(19) United States
(12) Patent Application Publication
(10) Pub. No.: US 2006/0026093 A1
(43) Pub. Date: Feb. 2, 2006

(54) System and method for providing financing over the internet

(75) Inventors: David M. Stump, Gowen, MI (US); Thomas L. Sturgeon, Ada, MI (US); Andrew J. Gamm, Belmont, MI (US); Attila Halasz, Walker, MI (US); Connie S. Johnston, Grand Rapids, MI (US); Terry L. DeGroot, Jenison, MI (US); Bijoy Pananghat, Grand Rapids, MI (US)

Correspondence Address: IN RE: ALTICOR INC. 28533;BRINKS, HOFER, GILSON & LIONE, P.O. BOX 10395, CHICAGO, IL, 60610, US

(73) Assignee: Quixtar Investments, Inc.

(21) Appl. No.: 10/909,582

(22) Filed: Aug. 2, 2004

(51) Int. Cl. G06Q 40/00

(52) U.S. Cl. 705/38

(57) ABSTRACT

The present invention relates to a system implemented in a computer for providing financing via a communications network. The system includes: a computer comprising a processor; a memory coupled with the processor and a network interface coupled with the processor and the memory and with the communications network; user interface logic stored in the memory and executable by the processor to receive an identifier associated with the customer via the network interface; status level tool logic stored in the memory and executable by the processor to determine, in conjunction with the user interface logic, a customer status level associated with the identifier; credit amount tool logic stored in the memory and executable by the processor to determine, in conjunction with the user interface logic, a credit amount available to the customer for applying to a purchase of a good or service based on the customer status level; and purchase tool logic stored in the memory and executable by the processor to permit, in conjunction with the user interface logic, the customer to apply the initial credit amount to a purchase of a good or service.

### BACKGROUND

The present invention relates generally to providing financing over the Internet, and more particularly, to providing financing for e-commerce commercial transactions based on credit information associated with a user.

Typically, commercial transactions on the Internet involve the sale of goods or services. Usually, a customer will purchase these goods or services with a credit card. While this is convenient for a merchant, potential sales may be lost when the consumer's credit cards are carrying high balances. Moreover, the interest rates associated with consumer credit cards may deter potential customers from making large purchases.

To eliminate the need for a credit card, many merchant sites offer deferred payment programs. These programs eliminate the consumer's reliance on credit card limits. Additionally, the interest rates offered through these programs may be lower than typical credit card interest rates. However, many of these types of programs require consumers to complete lengthy applications. Some consumers are wary of revealing personal and credit card information. Furthermore, each inquiry may tarnish the consumer's credit score, thus lowering their chances of being approved for subsequent credit opportunities.

Typically, the applications required by these deferred payment programs suffer from two deficiencies. First, many institutions require hard copies of the application to be submitted, such as by fax or mail. This increases the time required for approval, and may also deter consumers from making purchases. Second, those institutions that do allow for electronic application submission may not provide the consumer with a financing contract setting forth the specific provisions of the financing agreement. While contracts may be sent to a consumer via mail, the consumer is unable to view the full contract until after the transaction has been completed and the terms of the contract have been accepted.

Therefore, there is a need for a system that allows consumers to purchase items with a credit line without having to complete a lengthy credit application that may further reduce their credit score. Moreover, there is a need for a system that provides a consumer with a complete financing agreement in an electronic format before the consumer accepts an offer for financing.

### BRIEF SUMMARY

The present invention is defined by the following claims, and nothing in this section should be taken as a limitation on those claims. By way of introduction, the embodiments described below relate to a system implemented in a computer for providing financing via a communications network. The system includes: a computer comprising a processor; a memory coupled with the processor and a network interface coupled with the processor and the memory and with the communications network; user interface logic stored in the memory and executable by the processor to receive an identifier associated with the customer via the network interface; status level tool logic stored in the memory and executable by the processor to determine, in conjunction with the user interface logic, a customer status level associated with the identifier; credit amount tool logic stored in the memory and executable by the processor to determine, in conjunction with the user interface logic, a credit amount available to the customer for applying to a purchase of a good or service based on the customer status level; and purchase tool logic stored in the memory and executable by the processor to permit, in conjunction with the user interface logic, the customer to apply the initial credit amount to a purchase of a good or service.

In a second embodiment, a system implemented in a computer is provided for providing financing to a customer via a communications network from a merchant website offering for sale at least one good or service, the computer comprising a processor, a memory coupled with the processor and a network interface coupled with the processor and the memory and with the communications network. The system includes: user interface logic stored in the memory and executable by the processor to receive an identifier associated with the customer via the communications network, an order for one or more goods or services from the customer via the communications network, and a request for financing associated with the order via the communications network; approval tool logic stored in the memory and executable by the processor to determine, in conjunction with the user interface logic, whether to grant the request for financing; and contract generation tool logic stored in the memory and executable by the processor to generate, in conjunction with the user interface logic and in response to a signal from the approval tool, a contract, the contract including a plurality of terms binding the customer to repay a loan and capable of being stored electronically; wherein the user interface logic is further executable by the processor to present, electronically via the communications network, the contract to the customer and receive an acceptance of the contract from the customer.

### BRIEF DESCRIPTION OF THE DRAWINGS

FIG. 1 is an exemplary environment for an e-commerce commercial transaction.

FIG. 2 is an exemplary logical architecture for a merchant site for an e-commerce commercial transaction according to one embodiment.

FIG. 3 is a flow chart of an exemplary e-commerce commercial transaction according to one embodiment.

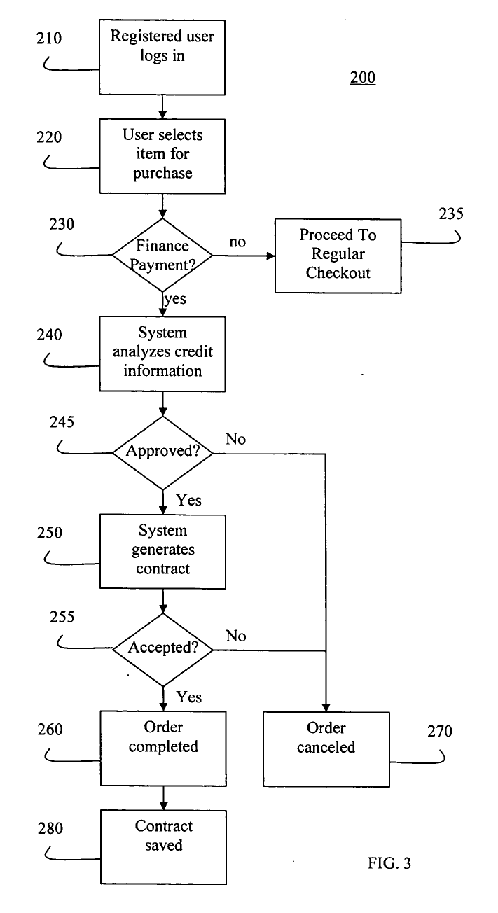

FIG. 4 is a flow chart of an exemplary customer approval process according to one embodiment.

FIG. 5 is an exemplary screen shot of a product display screen according to one embodiment.

FIG. 6 is a screen shot of an exemplary pre-approved financing chart according to one embodiment.

FIG. 7 is a screen shot of an exemplary sample financing contract according to one embodiment.

FIG. 8 is a screen shot of an exemplary financing shopping cart display screen according to one embodiment.

FIG. 9 is a screen shot of an exemplary order preview screen according to one embodiment.

FIG. 10 is a screen shot of an exemplary finance contract according to one embodiment.

FIG. 11 is a screen shot of an exemplary order confirmation screen according to one embodiment.

FIG. 12 is a screen shot of an exemplary user profile maintenance tool screen according to one embodiment.

### DETAILED DESCRIPTION

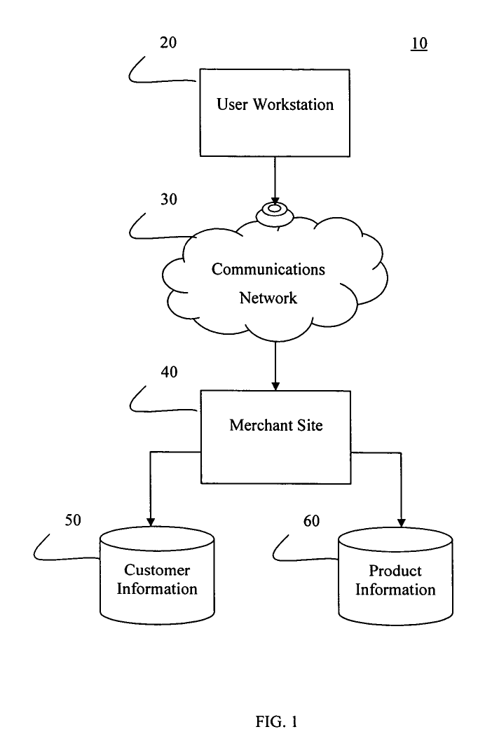

Referring now to the drawings and initially to FIG. 1, there is shown an exemplary system 10 for conducting an e-commerce commercial transaction. The system 10 includes a user workstation 20 coupled with a merchant website 40 via a communications network 30, such as the Internet or other publicly accessible network. It will be appreciated that a particular user may connect to this network via a private network, such as an Intranet. Herein, the phrase “coupled with” is defined to mean directly connected to or indirectly connected through one or more intermediate components. Such intermediate components may include both hardware and software based components. The user workstation may be a personal computer, personal digital assistant, cellular telephone, or any other suitable device capable of connecting to the communications network 30. The merchant site 40 is an e-commerce website that offers a variety of products or services for sale. In one embodiment, the merchant site is coupled with a customer information database 50 and a product and service information database 60. The customer information database 50 preferably stores information relating to users of the merchant site 40. This information may include username and password information, address information, user status information, user credit information and the like. The product and service information database 60 preferably stores information relating to products and services offered for sale on the merchant site. Such information may include stock keeping unit numbers (SKU's), pricing information, product and service descriptions, product usage information, quantity information, product and service classification information, product and service availability and the like.

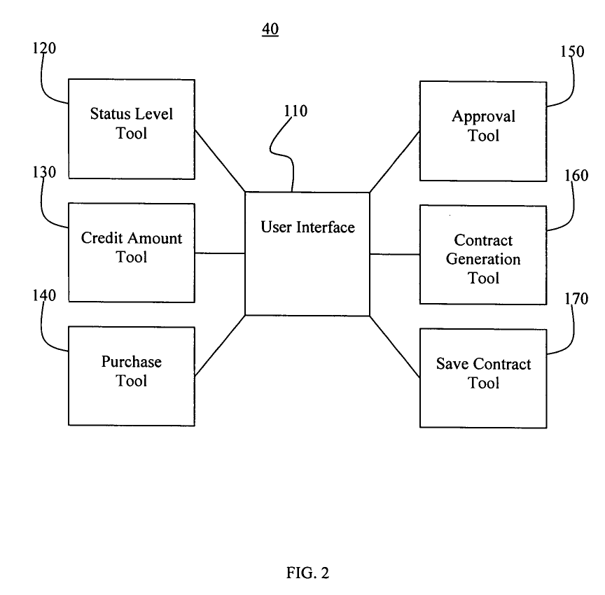

FIG. 2 shows an exemplary logical architecture for a merchant site 40 in accordance with one embodiment. The merchant site 40 includes a plurality of tools designed to allow users to purchase one or more products or services being offered for sale through merchant site 40. The exemplary site includes a user interface 110, a status level tool 120, a credit amount tool 130, a purchase tool 140, an approval tool 150, a contract generation tool 150, and a save contract tool 170. The user interface 110 may be adapted to accept user input, such as a customer identifier or username, as well as order information and other user inputs via known user interface controls. The user interface 110 may be adapted to display products and services and other pieces of information, both in graphical and textual formats . Moreover, the user interface 110 may be adapted to provide a communication link among the various other tools 120-170. In one embodiment, the user interface 110 is implemented as one or more World Wide Web pages using dynamic or static Hypertext Markup Language (“HTML”), Extensible Markup Language (“XML”), Application Server Pages, or combinations thereof as are known. The tools 120-170 may be implemented as graphic user interface elements of the user interface 110, such as menus, dialog boxes, buttons, etc. or may themselves be implemented as one or more World Wide Web pages. Further, the user interface 110 and tools 120-170 may be part of the merchant site 40 or offered as a service to the merchant site 40 via the network 30 by a third party. It will be further be appreciated that the functionality of one or more of the tools 120-170 may be combined into a single tool and that the provision of the described functionality is implementation dependent.

The status level tool 120 is coupled with the user interface 110 and, in one embodiment, is adapted to determine a customer status level associated with a customer identifier, as described below. The credit amount tool 130 is also coupled with the user interface 110 and, in one embodiment, is adapted to determine a credit amount available to a customer. The credit amount may be based on the customer status level or other factors, as described below. The purchase tool 140 is coupled with the user interface 110 and, in one embodiment, is adapted to allow a user to purchase products or services through the site 40. For example, the purchase tool 140 may collect order information, payment information, shipping information, and the like, secure the payment for any desired orders, complete an order and initiate the shipping process, as known. In one embodiment, the purchase tool 140 is adapted to allow users to purchase products or services with a credit amount provided by the merchant site 40, as discussed below.

The approval tool 150 is coupled with the user interface 110 and, in one embodiment, is adapted to verify credit information associated with a user, such as payment histories, history of credit fraud, credit ratings and the like, and determine whether to approve the purchase by credit of one or more products or services by a particular customer, as discussed below. The contract generation tool 160 is coupled with the user interface 110 and may be adapted to generate a contract binding a customer to repay a loan, as discussed below. In one embodiment, the contract may be generated in response to an approval from the approval tool 150. The save contract tool 170 is coupled with the user interface 110 and may be adapted to save accepted contracts for future reference or display, as described below. In one embodiment, the save contract tool 170 may be adapted to provide electronic versions of previously saved contracts on request.

Referring to the Figures, according to one embodiment a user, using the user workstation 20, connects to the merchant website 40 via a communications network 30, such as the Internet. Upon connecting to merchant site 40, the user is presented with the user interface 110, described above, and may log into the merchant site 40 by providing an identifier, such as a username and password uniquely identifying the user (block 210). After logging into the merchant site 40, the user may browse an electronic catalogue for products or services being offered for sale, as known in the art. The user may at any time select a product or service for purchase (block 220). Preferably, the merchant site 40 allows users to add items to a virtual “shopping cart”, as known in the art. The user may select a plurality of products or services for purchase, adding each item to the shopping cart, until the user has selected every product and/or service they wish to purchase. The user may then initiate a “check out” process whereby the order is finalized and payment information and shipping preferences are verified. Optionally, the user may be provided with multiple shopping carts. According to an alternative embodiment, a user does not log into merchant site 40 until after the user initiates the “check out” process.

The user then selects one or more products or services in the users “shopping cart” for which a financing payment option is available, and verifies their desire to purchase the selected products or services with financing (block 230). If the user does not wish to purchase the selected products with financing, the user may alternatively proceed to a regular checkout (block 235). In one embodiment, only products or services of a particular class are available for purchasing with financing. In alternate embodiments, financing payment options are available for all products and services. According to one embodiment, the user is provided with a “financing” shopping cart that only contains user selected items for which financing is available and desired. After the user has finished selecting products to be purchased with financing, the system analyzes customer credit information (block 240), such as by using the status level, credit amount and approval tools 120, 130, 150 described above. If the current transaction is approved (block 245), a contract is generated (block 250), such as by using the contract generation tool 160 described above. If the current transaction is not approved (block 245), the transaction may be canceled (block 270).

The system-generated financing contract may include the provisions necessary to create a binding financing contract. In one embodiment, the terms of the contract may be automatically varied to accommodate jurisdictional changes to comport with local law. For example, the terms may vary if the buyer is located in a particular geographical location. In one embodiment, the necessary information may include installment information, financing interest information, Truth In Lending disclosures, payment schedule information, an installment payment agreement, and the like. The installment information may include the total amount financed, finance charge information, an annual percentage rate, a total sale price for the products to be purchased and the like. The payment schedule may include monthly payment information, monthly principal and interest payments, payoff amount, and the like. The installment payment agreement may include provisions necessary to give legal affect to the contract. Instructions regarding execution of the contract and additional information may also be included in the contract. Regardless of the information included, each contract includes an accept button and a decline button. The user may electronically sign the contract and accept the terms therein by depressing the accept button. Alternatively, the user may decline the financing offer by depressing the decline button. In alternative embodiments, other methods of accepting and declining may be implemented, such as by providing a digital or encrypted signature or other method recognized by the controlling jurisdiction as a legally binding signature.

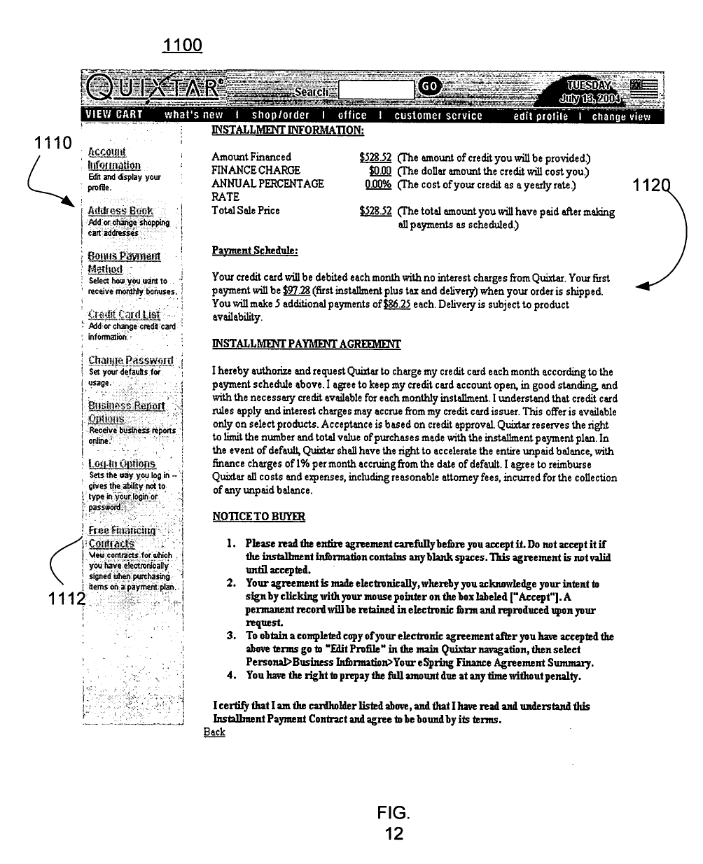

If the user accepts the contract (block 255), the order is processed (block 260). Order processing may include verifying the contents of an order, product shipment information, and the like. Invoice numbers for the processed order may also be provided. If the user declines to be bound by the contract (block 255), the order may be canceled (block 270). Finally, the electronic contract is saved to the customer information database 50 (block 280). In one embodiment, the stored contract is accessible by the user, such as via user profile maintenance features of the merchant web site 130, described below in reference to FIG. 12.

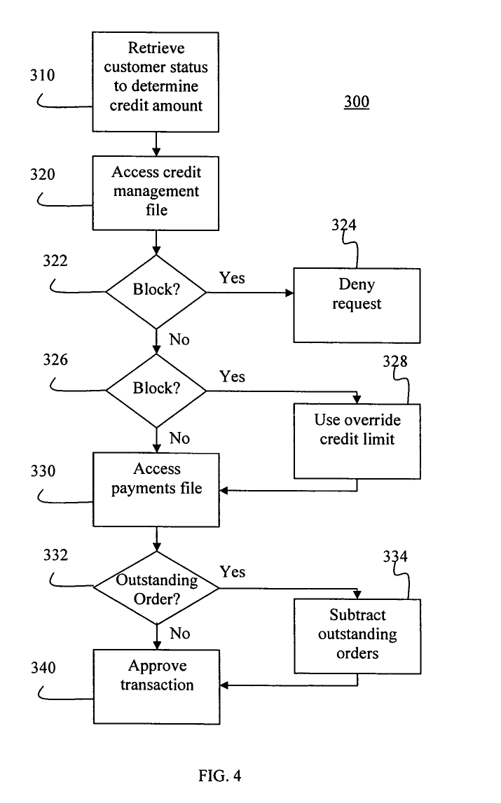

FIG. 4 shows a flow chart of an exemplary customer approval process according to one embodiment. Initially, customer status information is retrieved from customer information database 50. In one embodiment, each customer may belong to predefined status levels. Status levels may be determined based on any number of criteria, such as user's purchase history, credit rating, length of time registered with merchant and the like. In one embodiment, each user belongs to a multi-level marketing program which categorizes users by fulfillment type and class. For example, each user may belong to either a Standard Fullfillment (SF) or a Direct Fulfillment (DF) type. According to one embodiment, a SF multi-level marketing customer orders products from a product supplier for that multi-level marketing organization. Those products are shipped from the product supplier to a third party, who then delivers the product to the customer. According to one embodiment, a DF multi-level marketing customer orders products from a product supplier for that multi-level marketing organization. Those products are shipped directly from the product supplier to the customer. Exemplary classes include an associate independent business owner (IBO), 25% sponsor, Silver Producer, or Platinum Level, indicating the customers position within the hierarchy of the multi-level marketing organization. As used herein, a 25% sponsor is an IBO with a Silver Producer group downline. The credit amount tool 130 then determines a default pre-approved credit limit for the user based on the status level. For example, any user who has been registered for 90 days may have a credit limit of $700.00, whereas a user that has been registered for 30 days may have a credit limit of $100.00. According to an alternative embodiment, credit tool 130 determines a default pre-approved credit limit for the user based on the users fullfilment type or class within a multi-level marketing organization.

After determining the default pre-approved credit limit, the credit amount tool 130 accesses a credit management file (block 320). The credit management file includes information such as user ID number, credit limit type (such as a default or individual limit), credit block flag, credit block reason code, net Accounts Receivable balance, the user's credit score, the user's individual credit limit (if present), or a flag for whether a past due invoice exists for the user. In one embodiment, a batch process is used to obtain the net Accounts Receivable balance from an Account Management System designed to track account receivable information for a user and insert that information into the credit management file. The credit management file may be accessible to a Credit Manager or other employees of the merchant site 40, such as a credit department employee, for manually editing the information in the credit management file, such as entering a credit block or setting an individual credit level. In one embodiment, each user has an associated credit management file. In alternate embodiments, a single credit management file containing credit information for every user is maintained.

Once the credit management file has been accessed, the system determines whether the credit management file indicates a credit block (block 322) for a particular user. If a credit block is indicated, the system denies the credit request (block 324). After a denial, the user may be permitted to arrange for alternate payment means for completing the order. In one embodiment, the user is provided with a telephone number for contacting a customer service department to discuss alternate payment/credit options. Optionally, the credit management file may indicate a manual override (block 326) indicating an individual credit limit for the particular user. If such an override exists, the system will use the custom credit limit (block 328) in place of the previously determined default limit.

Once a credit limit for the user has been determined, the system accesses a payments file (block 330). The payments file may include information pertaining to the users outstanding orders, delivered orders, or back orders, which the user financed. In one embodiment, an associated payments file is maintained for each user. In alternate embodiments, a single payments file includes order information for a plurality of users. If outstanding credit orders exist (block 332), the total amount of the outstanding credit is subtracted from the determined credit limit to determine an available line of credit (block 334). Finally, the current order total is compared with the user's available line of credit. If the user's available line of credit is greater than or equal to the current order total, the transaction will be approved. If the user's available line of credit is less than the current order total, the transaction may be denied, or the user may be directed to call a customer service department to discuss alternate payment options. Alternatively, the system may apply the user's available line of credit to the current order total and allow the user to arrange for alternate payment means to cover any deficiency.

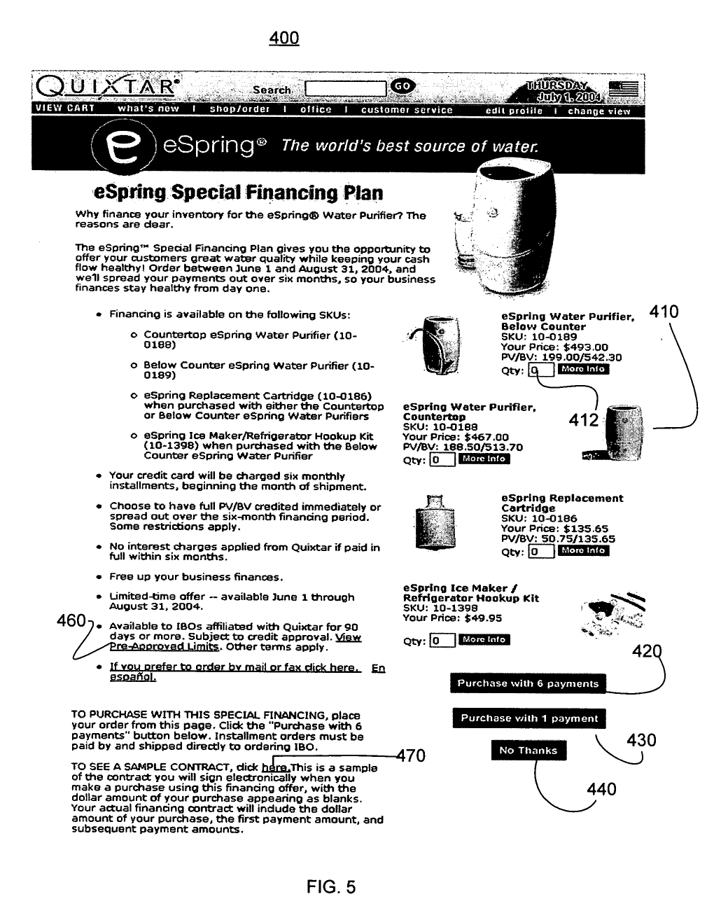

An exemplary transaction is shown in FIGS. 5-13. FIG. 5 shows an exemplary product display screen 400. The product display screen 400 displays a variety of products 410 for which financing is available. Controls 412 may also be provided to allow the user to enter the desired quantity for any of the available products 410. In one embodiment, the product display screen is implemented as one or more web pages. It will be appreciated that the design of the product display screen 400 is implementation dependent and that multiple product display screens 400 may be provided to implement the disclosed functionality or display information about one or more products or services. Once products and product quantities are selected, the user may select to purchase the products with financing by selecting the ‘purchase with 6 payments’ button 420. Alternatively, the user may select the ‘purchase with 1 payment’ button 430 to purchase the products. In alternative embodiments, other payment plans may be provided. For example, the merchant may allow the user to specify the number of payments to be made. The user may select to not purchase any products by selecting the ‘No Thanks’ button 440. As discussed above, a financing shopping cart may be provided for products that are eligible for purchasing with financing. The user may view the contents of the financing shopping cart by selecting the ‘View Financing Cart’ button 450.

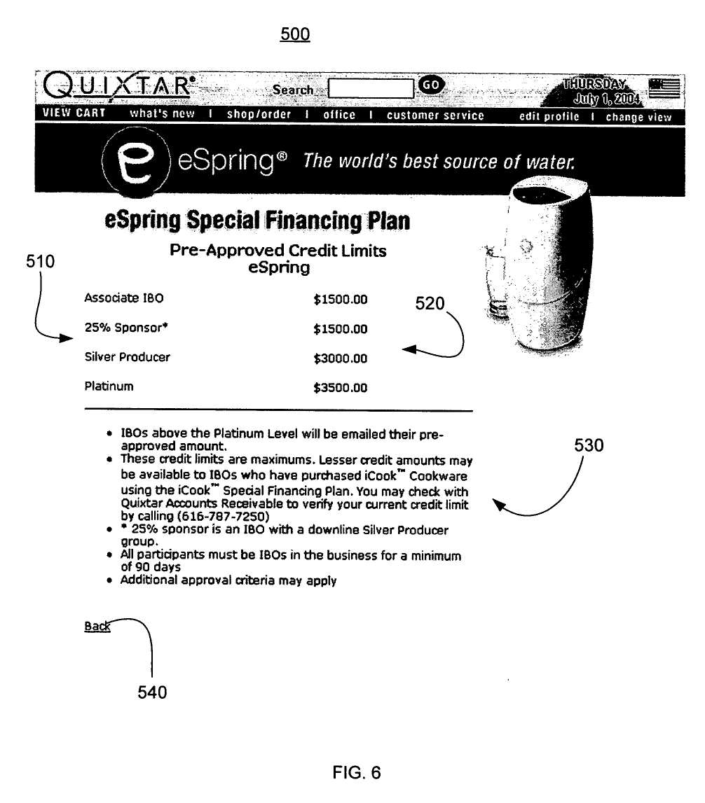

The user may elect to view the pre-approved credit limits by selecting the ‘view Pre-Approved Limits’ button 460. FIG. 6 shows a screen shot of an exemplary pre-approved financing chart 500. In one embodiment, the pre-approved financing chart 500 is implemented as one or more web pages. The chart 500 includes a list of user status levels 510 and the credit limits 520 corresponding to the various status levels 510. In one embodiment, the user status levels correspond to status levels of a multilevel marking organization. Optionally, additional information 530 relating to the credit limits may be provided. The user may return to the product display screen 400 by selecting the ‘back’ link 540 or the ‘back’ button provided by the web browser.

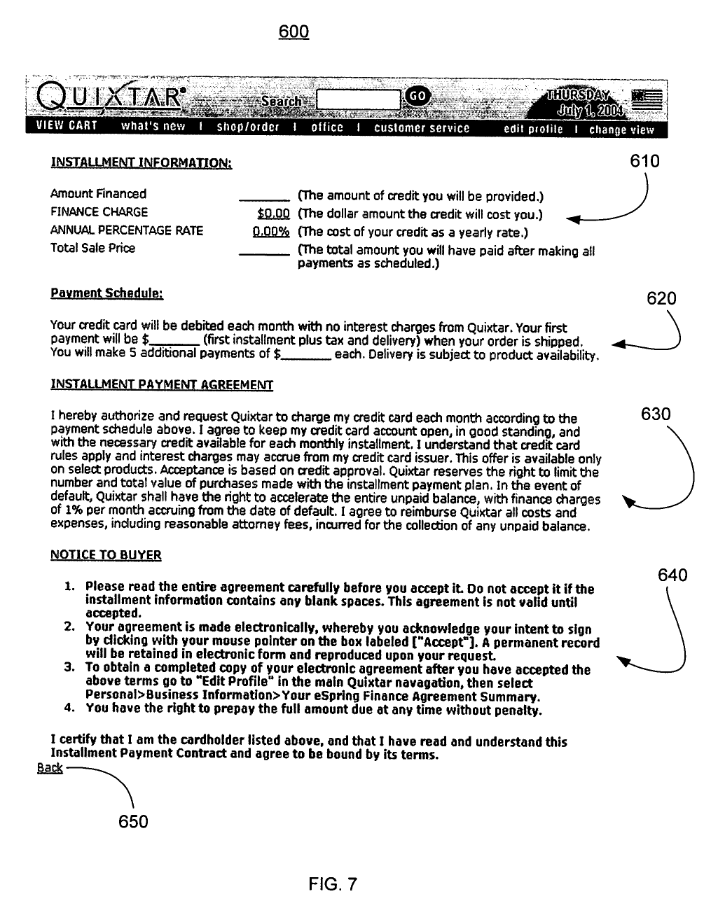

Returning to FIG. 5, the user may elect to view a sample financing contract by selecting the appropriate link 450. A screen shot of an exemplary sample financing contract 600 is shown in FIG. 7. In one embodiment, the sample financing contract 600 is implemented as one or more web pages. As discussed above, the system-generated financing contract may include the provisions necessary to create a binding financing contract. An exemplary financing contract is a truth in lending statement. As used herein, a “truth in lending statement” is any statement comporting, at least in part, with the Truth in Lending Act of 1968 (15 U.S.C. § 1601 et seq.). As shown in FIG. 7, the financing contract may include installment information 610. The installment information 610 can include an amount financed for the current transaction, finance charge information, annual percentage rate information, and a total sale price comprising the total amount the user will pay after making all scheduled payments. In a sample financing contract, this information may be blank or omitted.

Payment schedule information 620 may also be included in a sample financing contract 600. The payment schedule information 620 may set forth amounts for each payment under the terms of the contract. It will be appreciated that any suitable payment schedule may be displayed. In one embodiment, the sale price of the selected products may be paid in six equal installments, with any tax and service charges, such as a delivery charge, added to the initial payment. Alternatively, the tax and service charges may be apportioned over the life of the contract. According to alternative embodiments, the sales price may be paid according to any number of installments defined by the merchant, or according to any number of installments defined by the user.

Installment payment agreement information 630 may also be included in the sample financing contract 600. The installment payment agreement may include the provisions necessary to create a binding financing agreement. Exemplary provisions may include provisions for authorizing credit card charges, provisions for maintaining a given credit card account, provisions for certifying credit card account ownership, provisions for granting permission to obtain an independent credit report or similar credit check provisions, and acceleration provisions. Additional notices to the user 640 may also be provided in the sample financing contract. Exemplary additional notices 640 include notices that explain how to electronically sign the contract, or user rights and obligations. The user may return to the product display screen 400 by selecting the link 640 or the ‘back’ button provided by the web browser.

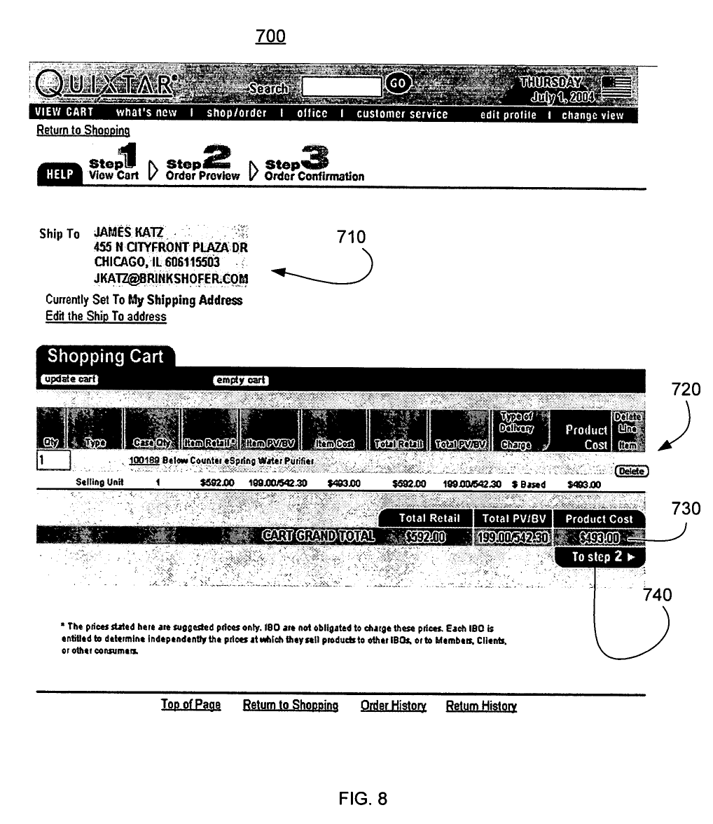

Returning to FIG. 5, the user may initiate a financing purchase by selecting the ‘Purchase with 6 payments’ button 420. In one embodiment, selection of the ‘Purchase with 6 payments’ button 420 will add the selected products 410 to the financing shopping cart and display the updated contents of the cart to the user. FIG. 8 shows a screen shot of an exemplary financing shopping cart display screen 700. In one embodiment, the financing shopping cart display screen 700 is implemented as one or more web pages. The financing shopping cart display screen 700 may include shipping information 710 and product information 720. The shipping information 710 may establish a destination address for the order. Controls may also be provided to allow the user to edit the currently designated shipping destination. The product information 720 may include quantities, product types, case quantities, retail value, item cost, delivery estimates, product descriptions and product numbers or SKUs. Reward program incentives may also be provided for each product 710. Controls may also be provided to allow a user to edit the contents of a shopping cart. For example, the user may be allowed to add products to the cart, edit product quantities for items in the cart, and remove items from the cart. Totals 730 may also be provided for the total cost of the order and the like. The user may go to the order preview screen by selecting the ‘To step 2’ button 740 as described below.

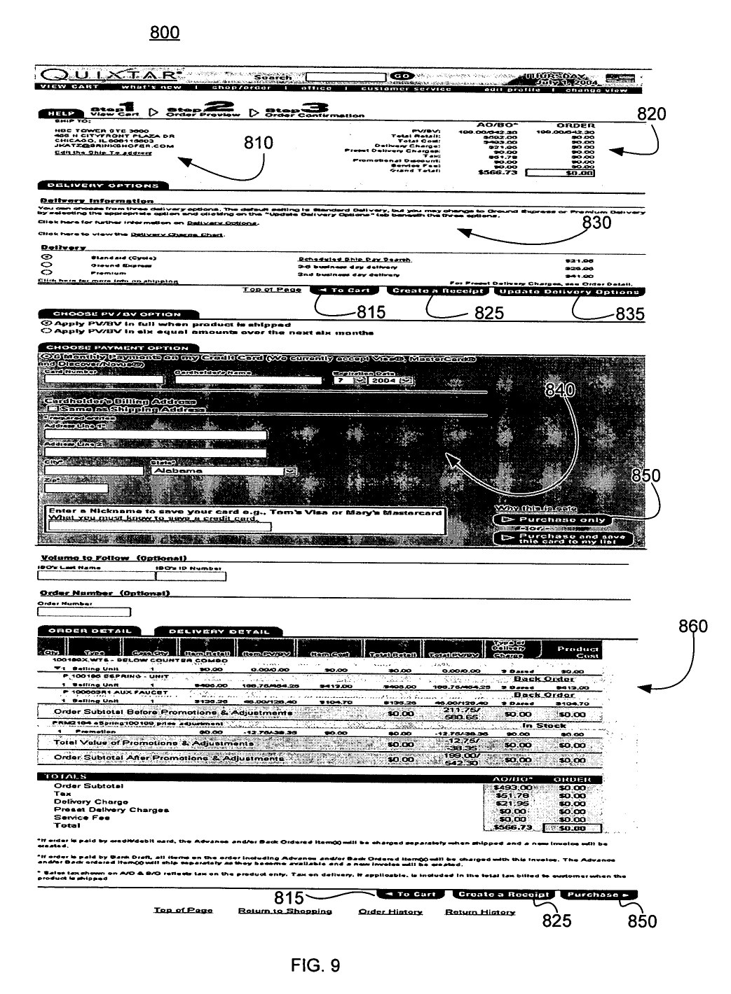

Upon selection of the ‘To step 2’ button 740, the user may be presented with an order preview screen. An exemplary order preview screen 800 is shown in FIG. 9. In one embodiment, the order preview screen 800 is implemented as one or more web pages. Shipping information 810 may be provided, and, as discussed above, controls may be provided to allow the user to edit the shipping information 810. Pricing information 820 may also be provided. Typical pricing information includes total cost, tax, delivery and handling charges and the like. The user may also select from available delivery options 830. The delivery options 830 may include standard shipping, ground express, premium shipping, such as 2nd business day shipping, and the like. The user may update the pricing information 820 to reflect a change in the shipping information 830 by selecting the ‘Update Delivery Options’ button 835. As all shipping options 830 may not necessarily be available for each product, the availability of shipping options 830 may be dynamically adjusted based on the products of a given order. In a similar manner the prices associated with each shipping option 830 may be altered dynamically to reflect shipping costs for the items of a given order. Additionally, controls may be added to allow the user to return to the shopping cart 815 to edit an order or to create a receipt for the current order 825. Optionally, order details 860 may be provided to allow the user to review the contents of an order.

Controls to collect payment information 840 may also be provided on the order preview screen 800. Payment information 840 may include the information necessary to pay for an order. Typically, a credit card is used to purchase e-commerce goods. The exemplary order preview screen 800 provides controls to acquire a credit card number, a cardholder name, a credit card type, and an expiration date. Other information may be collected to secure payment of the order, as known in the art, such as a checking account number and the like. Once payment information 840 is provided, the user may select the ‘Purchase’ button 850 to complete the order.

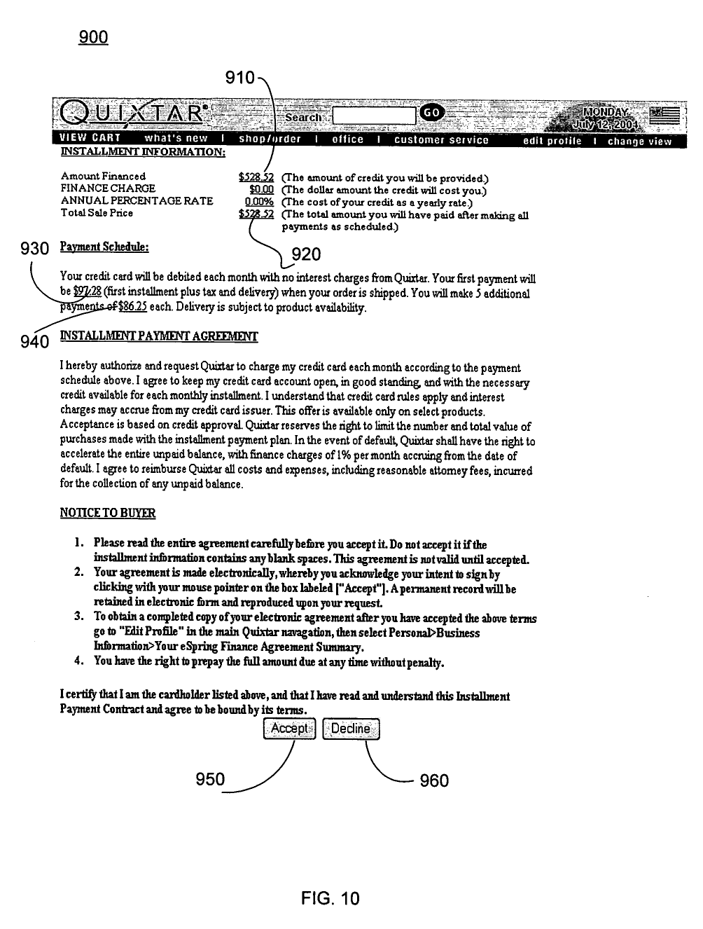

After selecting the ‘Purchase’ button 850, the user is presented with a finance contract. An exemplary finance contract 900 is shown in FIG. 10. In one embodiment, the finance contract 900 is implemented as one or more web pages. The contract contains the same provisions as the sample financing contract of FIG. 7, however, payment amounts are provided to reflect the current order. The financing contract 900 may include the amount financed 910, an applicable finance charge and the corresponding annual percentage rate, and a total sale price 920. As discussed above, the financing contract 900 may also include a payment schedule. In one embodiment, the sale price of the selected products may be paid in six equal installments, with any tax and service charges, such as a delivery charge, added to the initial payment. Accordingly, the first payment amount 930 and subsequent payment amounts 940 may be provided in the financing contract 900.

The user may electronically sign the financing contract by selecting the ‘Accept’ button 950. Upon acceptance, the order can be finalized and the contract can be saved for future reference. In one embodiment, accepted contracts are saved in a profile associated with the user. Alternatively, the user may decline the offer by selecting the ‘Decline’ button 960. The order may be deleted if the user declines the offer, or the user may be provided with the alternative payment options for the products or services in the financing shopping cart. For example, the user may be provided to pay for the products and services in the financing shopping cart using a credit card, money order, bank draft, or other payment options.

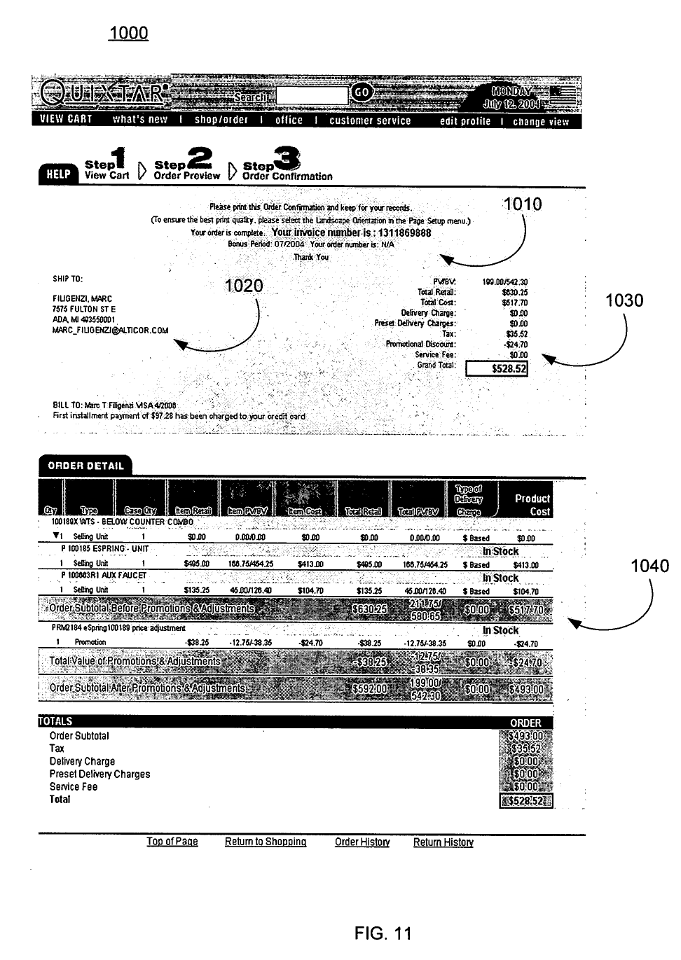

After the user accepts the financing contract and the order is finalized, an order confirmation screen 1000 may be provided, as shown in FIG. 11. In one embodiment, the order confirmation screen 1000 is implemented as one or more web pages. The order confirmation screen 1000 may include an invoice number 1010 for the finalized order. Additionally, the order confirmation screen 1000 may include shipping information 1020, pricing information 1030 and order detail information 1040, as described above.

Optionally, the user may access previously accepted contracts via user profile maintenance tools. An exemplary user profile maintenance tool screen 1100 is shown in FIG. 12. In one embodiment, the user profile maintenance tool screen 1100 is implemented as one or more web pages. The user may be provided with various options 1110 to edit his/her profile. Exemplary profile maintenance options include changing a password, editing a list of credit cards associated with the user, editing general account information, customizing login functions, and viewing accepted financing contracts. The user may select the ‘View Free Financing Contracts’ option 1112 from the list of options 1110. In response, a list of previously accepted financing contracts may be provided. Each item in the list may include an identifier that identifies the type of financing contract the user accepted and a date for when the contract was accepted. The previously accepted contract 1120 may be displayed upon selection of the corresponding item in the list. If no contracts have been previously accepted by the user, a message indicating that no accepted contracts exist may be provided.

While the invention has been described in conjunction with specific embodiments it is to be understood that many alternatives, modifications, and variations will be apparent to those skilled in the art in light of the foregoing detailed description. It is therefore intended that the foregoing description be regarded as illustrative rather than limiting, and that it be understood that it is the following claims, including all equivalents, that are intended to define the spirit and scope of this invention.

What is claimed:

1. A system implemented in a computer for providing financing via a communications network comprising:
a) a computer comprising a processor, a memory coupled with the processor and a network interface coupled with the processor and the memory and with the communications network;
b) user interface logic stored in the memory and executable by the processor to receive an identifier associated with the customer via the network interface;
b) status level tool logic stored in the memory and executable by the processor to determine, in conjunction with the user interface logic, a customer status level associated with the identifier;
c) credit amount tool logic stored in the memory and executable by the processor to determine, in conjunction with the user interface logic, a credit amount available to the customer for applying to a purchase of a good or service based on the customer status level; and
d) purchase tool logic stored in the memory and executable by the processor to permit, in conjunction with the user interface logic, the customer to apply the initial credit amount to a purchase of a good or service.

2. The system of claim 1, wherein the identifier is associated with a participant in a multilevel marketing organization.

3. The system of claim 2, wherein the customer status level corresponds to a status level associated with the multilevel marketing organization.

4. The system of claim 1, wherein the credit amount tool logic is further executable by the processor to access a credit management file including credit information associated with the identifier and to determine a second credit amount based in part on the credit information.

5. The system of claim 4, wherein the credit information includes at least one selected from the group consisting of a credit block and a manual override.

6. The system of claim 4, wherein the second credit amount is different from the initial credit amount.

7. The system of claim 4, wherein the second credit amount is the same as the initial credit amount.

8. The system of claim 4, wherein the credit amount tool logic is further executable by the processor to access a payment file, the payment file including payment information associated with the identifier, and to determine a third credit amount based at least in part on the payment information.

9. The system of claim 8, wherein the third credit amount is different from the second credit amount.

10. The system of claim 8, wherein the third credit amount is the same as the second credit amount.

11. The system of claim 8, wherein the payment information includes information relating to at least one order associated with the identifier.

12. A system implemented in a computer for providing financing to a customer via a communications network from a merchant website offering for sale at least one good or service, the computer comprising a processor, a memory coupled with the processor and a network interface coupled with the processor and the memory and with the communications network, the system comprising
a) user interface logic stored in the memory and executable by the processor to receive an identifier associated with the customer via the communications network, an order for one or more goods or services from the customer via the communications network, and a request for financing associated with the order via the communications network;
d) approval tool logic stored in the memory and executable by the processor to determine, in conjunction with the user interface logic, whether to grant the request for financing; and
e) contract generation tool logic stored in the memory and executable by the processor to generate, in conjunction with the user interface logic and in response to a signal from the approval tool, a contract, the contract including a plurality of terms binding the customer to repay a loan and capable of being stored electronically;
wherein the user interface logic is further executable by the processor to present, electronically via the communications network, the contract to the customer and receive an acceptance of the contract from the customer.

13. The system of claim 12, wherein the contract comprises a truth in lending statement.

14. The system of claim 12, further comprising
f) save contract tool logic stored in the memory and executable by the processor to store, electronically, the contract in response to receiving the acceptance.

15. The system of claim 14, wherein the contract is stored in a profile associated with the identifier.

16. The system of claim 14, wherein the user interface logic is further executable by the processor to provide a link to the stored contract

17. The system of claim 16, wherein the link is provided via profile maintenance tool logic.

18. A method for providing financing to a customer via a communications network from a merchant website offering for sale at least one good or service, the method comprising,
a) receiving an identifier associated with the customer;
b) determining a customer status level associated with the identifier;
c) determining an initial credit amount available to the customer for applying to a purchase of a good or service based on the customer status level; and
d) permitting the customer to apply the initial credit amount to a purchase of a good or service.

19. The method of claim 18, wherein the identifier is associated with a participant in a multilevel marketing organization.

20. The method of claim 19, wherein the customer status level corresponds to a status level associated with the multilevel marketing organization.

21. The method of claim 18, further comprising
d) accessing a credit management file, the credit management file including credit information associated with the identifier; and
e) determining a second credit amount based in part on the credit information.

22. The method of claim 21, wherein the credit information includes at least one selected from the group consisting of a credit block and a manual override.

23. The method of claim 21, wherein the second credit amount is different from the initial credit amount.

24. The method of claim 21, wherein the second credit amount is the same as the initial credit amount.

25. The method of claim 21, further comprising
f) accessing a payment file, the payment file including payment information associated with the identifier; and
g) determining a third credit amount based at least in part on the payment information.

26. The method of claim 25, wherein the third credit amount is different from the second credit amount.

27. The method of claim 25, wherein the third credit amount is the same as the second credit amount.

28. The method of claim 25, wherein the payment information includes information relating to at least one order associated with the identifier.

29. A method for providing financing to a customer via a communications network from a merchant website offering for sale at least one good or service, the method comprising
a) receiving an identifier associated with the customer;
b) receiving an order for one or more goods or services from the customer;
c) receiving a request for financing associated with the order;
d) determining whether to grant the request for financing;
e) generating, in response to the determining, a contract, the contract including a plurality of terms binding the customer to repay a loan and capable of being stored electronically;
f) presenting, electronically, the contract to the customer; and
g) receiving an acceptance of the contract from the customer.

30. The method of claim 29, wherein the contract comprises a truth in lending statement.

31. The method of claim 29, further comprising
f) storing, electronically, the contract in response to receiving the acceptance.

32. The method of claim 31, wherein the contract is stored in a profile associated with the identifier.

33. The method of claim 31, further comprising
g) providing a link to the stored contract.

34. The method of claim 33, wherein the link is provided via a profile maintenance tool.
